(19) United States
(12) Patent Application Publication
(10) Pub. No.: US 2011/0102590 A1
(43) Pub. Date: May 5, 2011

(54) SELF-SERVICE DEVICE COMPRISING A SURVEILLANCE UNIT

(75) Inventor: Guenter Holland-Letz, Paderborn (DE)

(73) Assignee: WINCOR NIXDORF INTERNATIONAL GMBH, Paderborn (DE)

(21) Appl. No.: 12/994,346

(22) PCT Filed: Jun. 26, 2009
(86) PCT No.: PCT/EP2009/004626

§ 371 Date: Nov. 23, 2010

(30) Foreign Application Priority Data
Jul. 2, 2008 (DE) 10 2008 031 281.9

(51) Int. Cl. H04N 7/18

(52) U.S. Cl. 348/143; 348/E07.085

(57) ABSTRACT

A self-service device (1), specifically a cash dispenser, account statement printer, and/or information or transaction terminal, having a basic housing (2), a control panel (3) with at least one screen (5) and one or more additional components (4, 6, 8, 9) and a surveillance apparatus (7), wherein the surveillance apparatus (7) is configured as a camera (7) and whose image information can be displayed on a screen (5) located in the area of the control panel (3), wherein the camera is located in such manner that an area behind a user of the self-service device (1) can be scanned.

### CROSS-REFERENCE TO RELATED APPLICATIONS

This application is a National Stage of International Application No. PCT/EP2009/004626, filed Jun. 26, 2009. This application claims the benefit and priority of German application 10 2008 031 281.9, filed Jul. 2, 2008. The entire disclosures of the above applications are incorporated herein by reference.

### BACKGROUND

This section provides background information related to the present disclosure which is not necessarily prior art.

1. Technical Field

The invention relates to a self-service device.

2. Discussion

Self-service devices of this type are known in the form of cash dispensers, for example, account statement printers and information or transaction terminals in widely different forms. The basic housing of a self-service device is designed in accordance with its particular purpose. The control panel is located in a position ergonomically favorable to the user. The components of the control panel may be, for example entry and output devices, card readers, display devices and keypads.

Entry devices may be, for example, card readers and cash deposit equipment. Output devices may be designed to issue bank notes and/or account statements, receipts and similar. The display devices are normally screens and/or displays.

The keypads serve to enter combinations of numbers to perform the user's particular action. The keypads may be configured not only as keys movable by touch but may also be integrated in the display as a so-called touch screen and be located next to, above or below the screen. Persons acting with intent to defraud preferably attempt in numerous way to spy out the PIN number entered by the user at cash dispensers.

In order to prevent such fraudulently acting persons from spying out PIN numbers, electrical and/or mechanical overlays are installed in the form of visual protection on the control panel or on the front of the cash dispenser. Another possibility is to use a transparent keypad to enter the PIN number under which a number display is disposed with an arrangement of numbers created by a random generator where the numbers can only be seen by looking directly from above onto the keypad.

The disadvantage of such visual protection overlays and keypads is that the user of a cash dispenser must constantly look around in order to ascertain whether a person standing behind him is trying to spy out his PIN number.

It has therefore been proposed, in particular for cash dispensers, in U.S. 2004/012773A1 to equip said dispensers with surveillance apparatus in the form of mirrors mounted on the side of the cash dispenser housing with which felonious intentions can be detected.

A surveillance apparatus of this type has proved its worth, but with this type of solution any change in the line of sight of the person using the cash dispenser is noticeable to the felon so that he is prewarned by the change in the user's line of sight and can immediately cease his attempts at spying.

### SUMMARY OF THE INVENTION

An object of the invention is to configure a self-service device of the type described in detail at the beginning in such a way that the surveillance unit or apparatus is simple in design but that it prevents spying with the greatest possible certainty.

Since the surveillance apparatus is designed as a camera and the image from this camera is transmitted onto a screen in the area of the control panel, components can be used that are intrinsically known from video surveillance and have proved themselves in practice. Using the surveillance apparatus, the user of a self-service device, without having to look round or even having to change his line of sight, can constantly observe the area behind him and thereby detect unobtrusively any attempt to spy by a person behind him.

The intention is therefore for there to be precisely one screen in the control panel on which the informational or transaction data and the image from the camera can be displayed, specifically as an image-within-image representation. As a result, it is optimally possible for the user to obtain the information he wishes or to carry out a transaction and at the same time observe the area behind him.

In a preferred embodiment it is intended that the camera is installed to one side of the control panel in the basic housing of the self-service device. This is accomplished in a simple manner, so that the camera can see past the user into the area behind the user and the image recorded by the camera can be shown on the control panel screen for the user so that said user can at all times detect any attempt to spy by a person behind him without having to turn away from the screen to do so.

Alternatively, a surveillance camera can be used to monitor the area around the self-service device that is installed above the self-service device on a ceiling or wall close to the self-service device and is electrically connected to the self-service device. As a result, such a surveillance camera can be used for an additional purpose, thus rendering superfluous the installation of an additional camera on or in the housing of the self-service device.

### BRIEF DESCRIPTION OF THE DRAWINGS

The invention is explained in greater detail using the attached drawings.

The drawings described herein are for illustrative purposes only of selected embodiments and not all possible implementations, and are not intended to limit the scope of the present disclosure.

FIG. 1 shows a preferred embodiment of a self-service device in accordance with the invention in the form of a cash dispenser,

FIG. 2 shows a schematic representation of the front of a preferred embodiment of a self-service device in accordance with the invention with screen and surveillance apparatus,

FIG. 3 shows a schematic plan view of a user standing in front of one embodiment of the invention,

FIG. 4 shows a schematic plan view of a user standing in front of a further embodiment.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

In the following description of the Figures, terms such as top, bottom, left, right, front, back etc. refer solely to the example depicted in the respective drawings and position of the self-service device and other parts. The terms are not be construed as restrictive, that is to say these references may change in different operating positions or as the result of a mirror-symmetrical layout or similar.

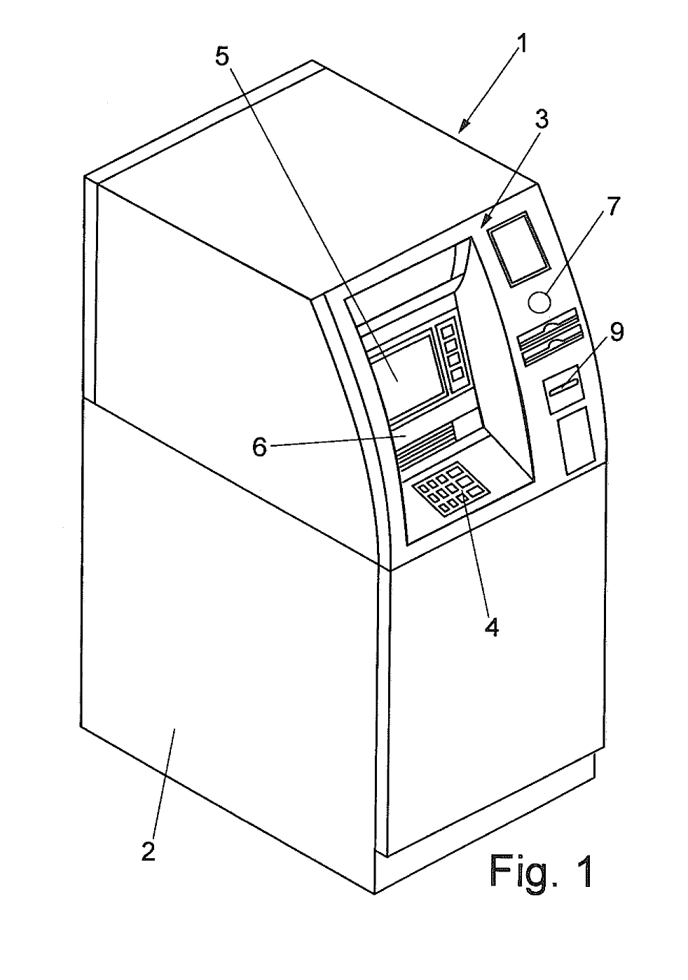

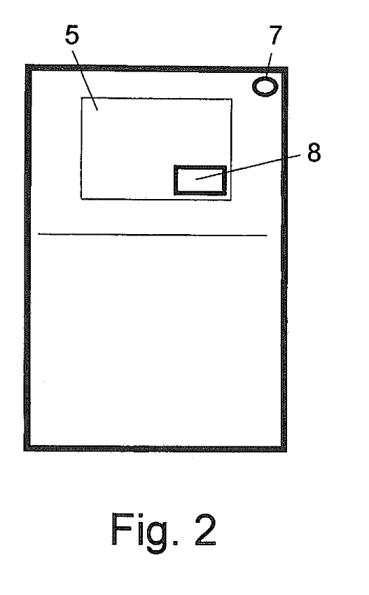

The self-service device shown in FIG. 1 is equipped with a basic cabinet 2. In the embodiment shown, a surveillance apparatus 7 is installed to the side of the operator with a control panel 3 in the upper area that is designed as a camera 7, specifically a live-image camera. The camera 7 is installed in the embodiment shown inside the basic housing 2, or rather the basic housing 2 is designed in such manner that the surveillance apparatus 7 lies within the basic housing 2. The control panel 3 in the embodiment shown is formed by a key pad 4, an input and/or output device 6 for banknotes, an input and/or output device 9 for identity cards and a screen 5. An arrangement of several screens for displaying different information separately, for example a display of operating functions on one screen and the camera image on another screen is also conceivable.

The camera 7 is arranged in such a way that it covers a space in front of the user's side of the self-service device 1, specifically a space behind a user located in front of the operator side of the self-service device. The pictorial information recorded by the camera can be transmitted and displayed via an electrical connection between camera 7 and screen 5 on at least a partial area of the screen 5.

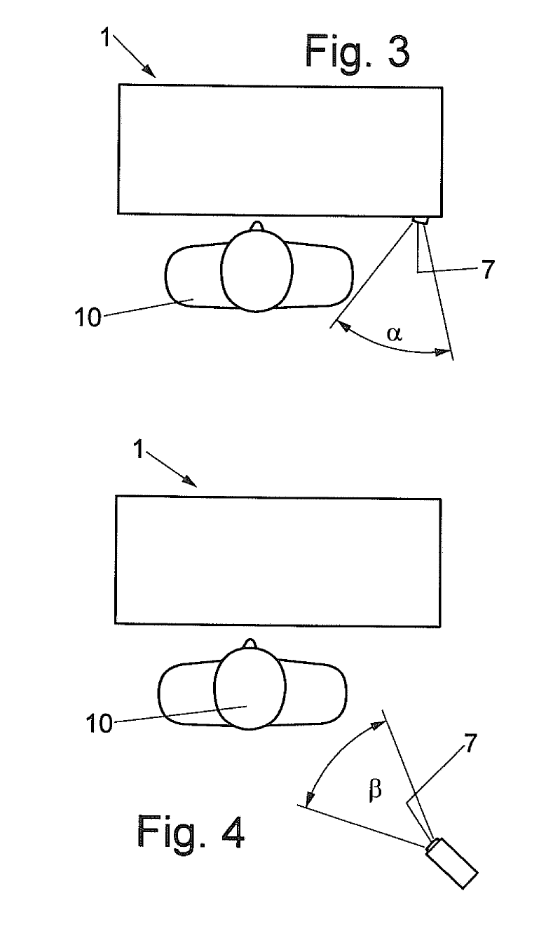

As shown in FIG. 3, the surveillance apparatus 7 is installed to the side of the control panel 3 in the housing 2 of the self-service device 1 so that a user of the self-service device does not cover the view of the surveillance device 7 of the area behind the user with his body. The angle of view α of the surveillance apparatus 7 is preferably adjustable so that, depending on the installation height of the surveillance apparatus 7 in the basic housing 1 and the height and location of the user 10, the angle α can be adjusted, for example, such that the surveillance apparatus 7 covers both an area to the side of as well behind the user. In a further embodiment of the self-service device 1, the surveillance apparatus 7 is installed above or below the control panel in the basic housing 2 of the self-service device 1. An arrangement of one camera to the left and right of the control panel 3 in the housing 2 of the self-service device 1 is also conceivable. It is essential that the surveillance apparatus 7 is disposed in such a manner that the area behind the user is visible for the surveillance apparatus while the self-service device 1 is being used.

The surveillance apparatus 7 and the controls for the screen 5 are connected electrically and arranged in such manner that a camera image 8 of the area behind a user of the self-service device 1 is displayed on the screen 5. Particularly preferably the controls for the screen 5 are arranged in such manner that the camera image 8 can be shown on the screen as an image-within-an image presentation.

As shown in FIG. 4, in an alternative embodiment a surveillance camera for the space or the environment around the self-service device can be used as the camera 7 that is not installed on or in the self-service device 1 itself but above the self-service device on a ceiling or wall close to the self-service device 1 and is electrically connected to the self-service device 1.

The invention is not restricted to the embodiment shown. It is especially advantageous that the surveillance apparatus is configured as a camera 7 so that the area to the rear behind a user of the self-service device 1 is covered and can be displayed on the screen 5 or screens of the control panel 3 so that the user can observe the space behind his back without having to look round or even turn around.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. Self-service device, specifically cash dispenser, account statement printer, and/or information or transaction terminal, having a basic housing, a control panel with a least one screen and one or more additional components and a surveillance apparatus, comprising wherein the surveillance apparatus is configured as at least one camera and its image information can be displayed on a screen disposed in the area of the control panel, wherein the camera is disposed in such manner that an area behind a user of the self-service device can be recorded.

2. Self-service device from claim 1, wherein precisely one screen is disposed in the control panel on which the information or transaction data and the image information from the camera can be transmitted and displayed.

3. Self-service device from claim 1, wherein the image information from the area behind the user can be displayed on a separate screen in the area of the control panel.

4. Self-service device from claim 3, wherein the image information from the camera can be displayed on the screen as an image-within-image representation.

5. Self-service device from claim 1, wherein the camera is installed to the side of the control panel in the basic housing of the self-service device.

6. Self-service device from claim 1, wherein a camera is installed to the left and right of the control panel in the basic housing of the self-service device.

7. Self-service device from claim 1, wherein the camera is installed above or below the control panel in the basic housing of the self-service device.

8. Self-service device from claim 1, wherein the camera is installed above the self-service device on a ceiling or wall close to the self-service device and is connected electrically to the self-service device.

9. Self-service device from claim 1, wherein the camera and the controls for the screen are laid out and connected electrically in such manner that a live camera image of the area behind a user of the self-service device is displayed on the screen.
